(19) United States
(12) Patent Application Publication
(10) Pub. No.: US 2017/0116284 A1
(43) Pub. Date: Apr. 27, 2017

(54) Surfacing Inferred Actions in Search

(71) Applicant: Google Inc., Mountain View, CA (US)

(72) Inventors: Amay Nitin Champaneria, San Francisco, CA (US); Bote Deepak Narayan, Sunnyvale, CA (US); Srihari H. Reddy, Santa Clara, CA (US)

(73) Assignee: Google Inc., Mountain View, CA (US)

(21) Appl. No.: 14/143,250

(22) Filed: Dec. 30, 2013

Related U.S. Application Data
(60) Provisional application No. 61/905,932, filed on Nov. 19, 2013.

(51) Int. Cl. G06F 17/30

(52) U.S. Cl. CPC G06F 17/30522

(57) ABSTRACT

Methods, systems, and apparatus, including computer programs encoded on a computer storage medium, for receiving a search query, receiving a set of inferred actions, the set of inferred actions including one or more inferred actions that are based on the search query and being identified based on data provided in one or more data sources, providing an electronic document including instructions that, when executed by a computing device, cause the computing device to display a search results page including search results and content associated with inferred actions of the set of actions, and transmitting the electronic document to a computing device associated with a user that submitted the search query.

### CROSS REFERENCE TO RELATED APPLICATIONS

This application claims priority under 35 U.S.C. §119 to U.S. Provisional Patent Application No. 61/905,932, filed Nov. 19, 2013, and entitled “Surfacing Inferred Actions in Search,” the entire contents of which are incorporated by reference herein.

### BACKGROUND

The Internet provides access to a wide variety of resources, such as image files, audio files, video files, and web pages. A search system can identify resources in response to queries submitted by users and provide information about the resources in a manner that is useful to the users. The users can navigate through, e.g., click on, search results to acquire information of interest.

### SUMMARY

This specification relates to presenting data with search results.

Implementations of the present disclosure are generally directed to surfacing inferred actions in search. More particularly, implementations of the present disclosure are directed to displaying content associated with one or more inferred actions in response to a received search query.

In general, innovative aspects of the subject matter described in this specification can be embodied in methods that include actions of receiving a search query, receiving a set of inferred actions, the set of inferred actions including one or more inferred actions that are based on the search query and being identified based on data provided in one or more data sources, providing an electronic document including instructions that, when executed by a computing device, cause the computing device to display a search results page including search results and content associated with inferred actions of the set of actions, and transmitting the electronic document to a computing device associated with a user that submitted the search query. Other implementations of this aspect include corresponding systems, apparatus, and computer programs, configured to perform the actions of the methods, encoded on computer storage devices.

These and other implementations can each optionally include one or more of the following features: an inferred action in the set of inferred actions includes submission of a search query; content associated with an inferred action includes a search result that would be displayed, if a search query associated with the inferred action were to be submitted; actions further include providing a superset of inferred actions, and filtering the superset of inferred actions to provide the set of inferred actions; actions further include determining that inferred actions are to be represented in search results in response to a determination that one or more items are to be displayed in the search results; the one or more items include at least one of a personal search result and a knowledge panel; the one or more inferred actions are further based on search results that are responsive to the query; data provided in the one or more data sources includes aggregate user data; and at least one data source of the one or more data sources includes a search log.

Particular implementations of the subject matter described in this specification can be implemented so as to realize one or more of the following advantages. In some examples, the inferred actions include actions that users are likely to next perform. In some examples, by displaying content associated with inferred actions, a user can see the results of actions they would likely perform, without having to actually perform the actions. In this manner, bandwidth and/or processing time is conserved, because the user need not actually perform inferred actions. In some examples, by displaying content associated with inferred actions, the user can see the results of actions that other users would likely perform. In this manner, the user can be informed as to other actions that the user themselves might not have otherwise performed.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a search system provides search services.

FIGS. 2A and 2B depict example inferred actions based on respective example search queries.

FIGS. 3A and 3B depicts example inferred actions based on an example search query, user attributes, and respective seasonal indicators.

FIG. 4 depicts an example process that can be executed in accordance with implementations of the present disclosure.

FIG. 5 depicts a screen shot of an example search interface in which content associated with inferred actions is presented with search results in a search results page.

Like reference numbers and designations in the various drawings indicate like elements.

### DETAILED DESCRIPTION

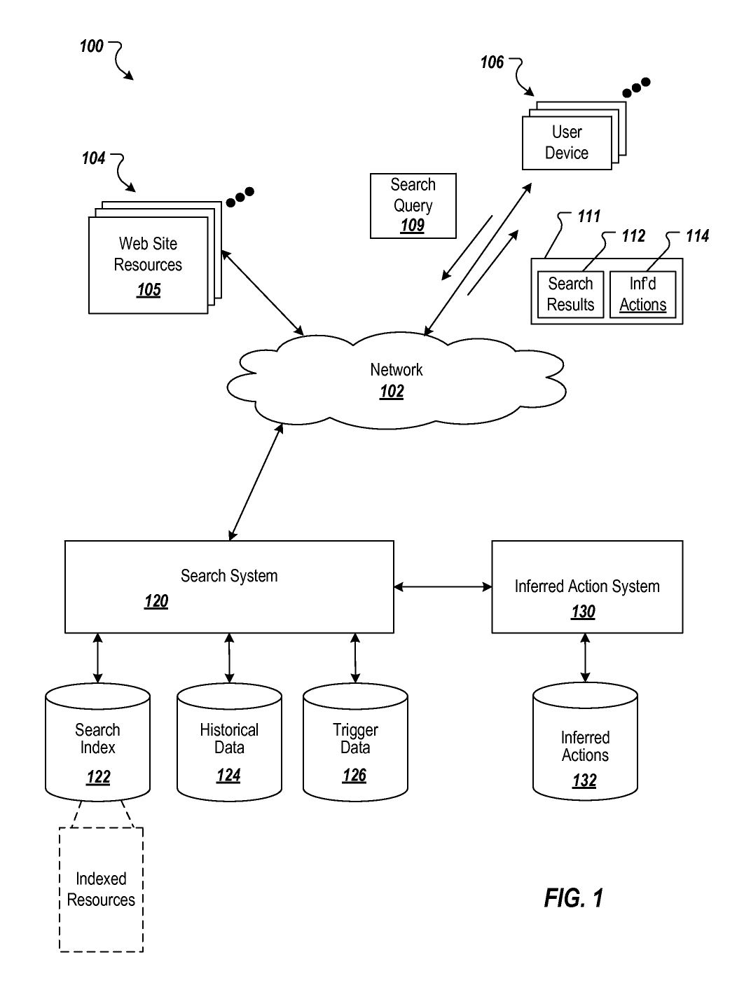

FIG. 1 depicts an example environment 100 in which a search system 120 provides search services. The example environment 100 includes a network 102, e.g., a local area network (LAN), wide area network (WAN), the Internet, or a combination thereof, connects web sites 104, user devices 106, and the search system 120. In some examples, the network 102 can be accessed over a wired and/or a wireless communications link. For example, mobile computing devices, such as smartphones can utilize a cellular network to access the network. The environment 100 may include millions of web sites 104 and user devices 106.

In some examples, a web site 104 is provided as one or more resources 105 associated with a domain name and hosted by one or more servers. An example web site is a collection of web pages formatted in an appropriate machine-readable language, e.g., hypertext markup language (HTML), that can contain text, images, multimedia content, and programming elements, e.g., scripts. Each web site 104 is maintained by a publisher, e.g., an entity that manages and/or owns the web site.

In some examples, a resource 105 is data provided over the network 102 and that is associated with a resource address, e.g., a uniform resource locator (URL). In some examples, resources 105 that can be provided by a web site 104 include web pages, word processing documents, and portable document format (PDF) documents, images, video, and feed sources, among other appropriate digital content. The resources 105 can include content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources 105 over the network 102. Example user devices 106 include personal computers, mobile computing devices, e.g., smartphones and/or tablet computing devices that can send and receive data over the network 102. As used throughout this document, the term mobile computing device (“mobile device”) refers to a user device that is configured to communicate over a mobile communications network. A smartphone, e.g., a phone that is enabled to communicate over the Internet, is an example of a mobile device. A user device 106 typically includes a user application, e.g., a web browser, to facilitate the sending and receiving of data over the network 102.

In some examples, to facilitate searching of resources 105, the search system 120 identifies the resources 105 by crawling and indexing the resources 105 provided on web sites 104. Data about the resources 105 can be indexed based on the resource to which the data corresponds. The indexed and, optionally, cached copies of the resources 105 are stored in a search index 122.

The user devices 106 submit search queries 109 to the search system 120. In some examples, a user device 106 can include one or more input modalities. Example modalities can include a keyboard, a touchscreen and/or a microphone. For example, a user can use a keyboard and/or touchscreen to type in a search query. As another example, a user can speak a search query, the user speech being captured through a microphone, and being processed through speech recognition to provide the search query.

In response to receiving a search query 109, the search system 120 accesses the search index 122 to identify resources 105 that are relevant to, e.g., have at least a minimum specified relevance score for, the search query 109. The search system 120 identifies the resources 105, generates a search results display 111 that includes search results 112 identifying resources 105, and returns the search results display 111 to the user devices 106. In an example context, a search results display can include one or more web pages, e.g., one or more search results pages. In some examples, a web page can be provided based on a web document that can be written in any appropriate machine-readable language. It is contemplated, however, that implementations of the present disclosure can include other appropriate display types. For example, the search results can be provided in a display generated by an application that is executed on a computing device, and/or a display generated by an operating system, e.g., mobile operating system. In some examples, search results can be provided based on any appropriate form, e.g., Javascript-html, plaintext.

A search result 112 is data generated by the search system 120 that identifies a resource 105 that is responsive to a particular search query, and includes a link to the resource 105. An example search result 112 can include a web page title, a snippet of text or a portion of an image extracted from the web page, and the URL of the web page. In some examples, data provided in the search results 112 can be retrieved from a resource data store. For example, the search system 120 can provide the search results display 111, which displays the search results 112. In some examples, the search results display 111 can be populated with information, e.g., a web page title, a snippet of text or a portion of an image extracted from the web page, that is provided from the resource data store.

In some examples, data for the search queries 109 submitted during user sessions are stored in a data store, such as the historical data store 124. For example, the search system 120 can store received search queries in the historical data store 124.

In some examples, selection data specifying actions taken in response to search results 112 provided in response to each search query 109 are also stored in the historical data store 124, for example, by the search system 120. These actions can include whether a search result 112 was selected, e.g., clicked or hovered over with a pointer). The selection data can also include, for each selection of a search result 112, data identifying the search query 109 for which the search result 112 was provided.

In accordance with implementations of the present disclosure, the example environment 100 also includes an inferred action system 130 communicably coupled to the search system 120, e.g., directly coupled or coupled over a network such as network 102. In some examples, the search system 120 can interact with the inferred action system 130 to provide one or more inferred actions in view of the search query 109 and/or the search results 112. In some examples, the inferred action system 130 can provide inferred actions that can be represented with the search results 112 based on inferred actions stored in an inferred actions data store 132. For example, inferred action content 114, which includes content associated with an inferred action can be provided in the search results display 111. In some examples, the inferred actions data store 132 may include inferred actions that are provided based on aggregate user actions. In some examples, inferred actions can include a search that the user could perform and/or that a user is likely to perform.

In some implementations, the inferred actions system 130 may receive the search query and/or the search results from the search system 120. In response, the inferred actions system 130 can provide a set of inferred actions to the search system 120. In some examples, the set of inferred actions can include one or more inferred actions. In some implementations, the inferred actions system 130 can provide the set of inferred actions, where content associated with one or more inferred actions of the set of inferred actions can be displayed in the search results display 111.

In some implementations, the search system 120 can provide one or more items to be included in the search results display 111. In some examples, an item can include a personal search result, e.g., a user-specific data record. In some examples, an item can include a knowledge panel. In some examples, and as discussed in further detail herein, content associated with inferred actions can be displayed based on whether an item is to be displayed with search results.

In some examples, and with respect to items including user-specific data records, the example environment 100 can also include a data record system (not shown) communicably coupled to the search system 120, e.g., directly coupled or coupled over a network such as network 102. In some examples, the search system 120 can interact with the data record system to provide one or more data records that are specific to the user that submitted the search query 109. In some examples, the data record system 130 can provide data records that can be included with the search results 112, and the inferred action content 114, based on data records stored in a data records data store. In some examples, the data records data store may include information specific to the user that submitted the search query 109. In some examples, the data records data store may include this data for many different users. In some examples, the data records data store may be a dedicated data store specific to the user submitting the search query 109.

In some implementations, the data record system may receive the search query and an identification of the user from the search system 120. For example, the user can be logged into a search service that provides the search system 120. In response, the data record system can provide a set of data records to the search system 120. In some examples, the set of data records can include one or more data records. In some implementations, the data record system can provide the set of data records that can be displayed in the search results display 111.

In some examples, a data record can be specific to a user and can be generated based on one or more electronic documents associated with the user. For example, an electronic document can include data that can be used to populate a data record. Example electronic documents can include electronic mail messages, instant messages (IMs), short message system (SMS) messages, social networking posts, word processing documents, images, e.g., image recognition, optical character recognition, barcodes, electronic calendar items, electronic meeting invitations, audio transcripts, or other appropriate sources of information.

In some examples, an electronic document can be associated with a category. Example categories can include travel, e.g., travel reservations, lodging, e.g., hotel reservations, commerce, e.g., product purchases, events, e.g., theater performances, movies, concerts, sporting events, and restaurants, e.g., restaurant reservation. In some examples, the electronic document can convey a booking confirmation, travel itinerary, hotel reservation confirmation, shipment notification, order tracking update, purchase receipt, restaurant reservation confirmation, or other appropriate forms of data. In some examples, a category of an electronic document can be determined based on an identifier and/or data provided in the electronic document.

In some examples, a data record can be specific to a category, and fields in the plurality of fields can be relevant to the category. For example, the data record can be specific to the flight reservation category and can include category-specific data fields, e.g., confirmation number, flight number, departure airport, arrival airport, departure date/time, arrival date/time. As another example, the data record can be specific to the hotel reservation category and can include category-specific data fields, e.g., reservation number, check-in date, check-out date, room rate, room type. As another example, the data record can be specific to the purchases category and can include category-specific data fields, e.g., product name, product identifier, quantity, cost, estimated shipping date, actual shipping date, tracking number.

The data record, once populated, is stored in a data repository, e.g., the data records data store. In some implementations, the data repository can include one or more tables in one or more databases, one or more flat files, or combinations of these and any other appropriate format for the storage and retrieval of information such as data records.

In some examples, and with respect to items including knowledge panels, the example environment 100 also includes a knowledge panel system (not shown) communicably coupled to the search system 120, e.g., directly coupled or coupled over a network such as network 102. The search system 120 can interact with the knowledge panel system to determine whether to provide a knowledge panel within the search results display 111. If it is determined that a knowledge panel should be provided, the knowledge panel system can generate the knowledge panel and provide the generated knowledge panel to the search system 120. In some examples, and as discussed in further detail herein, the knowledge panel can be displayed in-line with search results, e.g., at the top of the search results page, in the middle of the search results page, at the bottom of the search results page, or the knowledge panel can be displayed adjacent to the search results, e.g., on the right-hand-side or the left-hand-side of the search results page.

In some examples, a knowledge panel can be provided for queries that have been determined to reference a particular entity, such as a person, place, country, landmark, animal, historical event, organization, business, sports team, sporting event, movie, song, album, game, work of art, or any other entity. For example, one or more topics can be determined from the submitted search query, and it can be determined that the one or more topics correspond to a topic, for which a knowledge panel is available. In response, the knowledge panel can be triggered for display. In some examples, whether to display a knowledge panel can be determined based on a set of rules.

In general, a knowledge panel for a particular entity can include content related to the particular entity. In some implementations, a knowledge panel includes a set of factual information deemed relevant to the particular entity. For example, a knowledge panel for an actor may include biographical information for the actor, as well as content associated with movies or television shows that the actor has appeared. In some implementations, the knowledge panel includes a summary of information related to the particular entity. For example, a knowledge panel for a nation may include a map of the nation, the flag of the nation, the official language of the nation, and/or other facts and content related to the nation. In some examples, information provided in the knowledge panel can be pulled from one or more resources, e.g., the resources 105, and can be merged to populate the knowledge panel.

In some examples, the knowledge panel system includes or is communicably coupled to one or more data storage units that include a content items store and a knowledge panel templates store. The content items store stores content items that can be inserted into a knowledge panel. In general, the content items are discrete units of content and can be in the form of text, images, videos, graphics, audio, tables, or other types of content.

In some implementations, the content items store includes an index of entities and data identifying content items relevant to the entities. For example, the index may include data identifying a title for an entity, one or more images relevant to the entity, a description of the entity, one or more facts about the entity, one or more videos relevant to the entity, upcoming events related to the entity, content from a social networking page associated with the entity, and other information or types or categories of content that have been deemed relevant to the entity.

The content items for each entity can come from disparate sources and/or disparate publishers. For example, content items for a particular entity can be obtained from several different web pages or other resources that are each hosted by different publishers. To illustrate, the content items for a particular actor may include images of the actor received from several different sources and these images can be included in the same knowledge panel that is provided in response to a query that references the particular actor. As another example, an image of a person may be obtained from an official site for the person, and a set of facts and/or description for the person may be obtained from an online encyclopedia.

In some implementations, the knowledge panel system identifies content items for each of a set of entities by crawling the Internet for content related to the entity. The knowledge panel system can also determine which of the obtained content items to provide with a knowledge panel for the entity. For example, some of the content items may be more relevant to the entity or more appropriate for the knowledge panel than other content items. As an example, an image of a person's face may be more appropriate for a knowledge panel than an image of the person taken from a long distance.

The type or categories of content provided in a knowledge panel may be determined based on the particular entity or the type of entity referenced by the knowledge panel. For example, a knowledge panel for a person may include an image of the person, facts about the person, and references to any public works produced by the person. By way of another example, a knowledge panel for a landmark may include images of the landmark, facts about the landmark, and travel information, such as a map, for a person to travel to the landmark. The categories of content that are included in a knowledge panel can also vary based on the particular entity. For example, a person that has acted in movies and that has also recorded one or more albums may include references to both types of works. A knowledge panel template may specify the content for a knowledge panel, as described in more detail below.

Although different types of content can be provided for different types of entities and/or different entities within an entity type, the knowledge panels can be configured to provide a recognizable and consistent user interface for users. In some implementations, each knowledge panel can have one or more standard types of content items. For example, the standard types of content items can include a title, an image, a description, and one or more facts about the entity for which the knowledge panel is provided. Implementations of the present disclosure are generally directed to surfacing inferred actions in search. More particularly, implementations of the present disclosure are directed to displaying content associated with one or more inferred actions in response to a received search query. In some implementations, the content associated with the one or more inferred actions can be displayed with search results. In some implementations, the one or more inferred actions can be provided based on data of one or more data sources. An example inferred action can include a search that a user could perform. In some example, the search can include a search that a user is likely to perform in view of the search results and/or the search query.

In some implementations, content associated with the one or more inferred actions can be displayed with search results. In some examples, content can include one or more suggested searches. For example, the user can select, e.g., click on, a suggested search to induce execution of the suggested search. In some examples, content can include search results that would be displayed based on the one or more inferred actions.

In some implementations, it can be determined that an item is to be displayed in search results. In some examples, content associated with the one or more inferred actions can be displayed in response to determining that an item is to be displayed. In some examples, an item can include a personal search result, e.g., a data record, discussed above. In some examples, a personal search result can include a search result that is specific to a user that submitted a search query, the search query prompting the display of search results. In some examples, the personal search result includes user-specific data. In some examples, an item can include a knowledge panel, discussed above. In some examples, a knowledge panel is associated with a particular subject matter and can include content related to the particular subject matter.

In some implementations, a superset of inferred actions can be provided based on the search query and/or the search results. In some implementations, the superset of inferred actions can be filtered to provide a set of inferred actions. In some examples, the superset of inferred actions can be filtered based on time, date, and/or one or more attributes associated with the user that submitted the search query, e.g., the searching user.

In some examples, relevance of an inferred action can be affected by time. For example, an inferred action that is directed to breakfast restaurants might not be relevant to a time indicative of afternoon and/or evening. In some examples, relevance of an inferred action can be affected by date. For example, an inferred action that is directed to a winter sporting activity, e.g., skiing, might not be relevant to a date indicative of spring, summer or fall seasons. In some examples, this can depend on region. For example, seasons can be relative based on hemispherical location, e.g., summer in the northern hemisphere is winter in the southern hemisphere.

In some examples, relevance of an inferred action can be affected by one or more attributes associated with the user that submitted the search query. In some examples, attributes can include topics that the user has been determined to be interested in. Non-exhaustive, example topics can include music, sports, food, technology, gardening, airplanes, cars, movies, video games and the like. For example, an inferred action that is directed to a winter sporting activity, e.g., skiing, might be relevant to a user that has been determined to be interested in winter sports, but might not be relevant to another user.

Implementations of the present disclosure will be described in further detail with reference to an example context. In the example context, a data source includes one or more search logs. In some examples, a search log provides data corresponding to one or more search queries submitted to a search system, and/or selection of search results. Search logs can be provided, for example, in a data store, e.g., the historical data 124 of FIG. 1. It is appreciated, however, that implementations of the present disclosure are applicable in other appropriate contexts using any appropriate data source(s).

In some implementations, where user information is collected or used by systems discussed here, or systems discussed here make use of user information, e.g., information about submitted search queries and/or navigation of search results, users can be given an opportunity to control whether the user information is collected. In some implementations, users are given the opportunity to control whether and/or how to receive content that may be more relevant to the user. In addition, certain data may be treated in one or more ways before it is stored or used, so that personally identifiable information is removed. For example, a user's identity is treated so that no personally identifiable information can be determined for the user, or a user's geographic location is generalized so that a particular location of a user cannot be determined.

In accordance with the example context, one or more search logs can be processed to determine one or more inferred actions based on search queries submitted to a search service.

In this manner, inferred actions are based on aggregate user actions. For example, for a particular search query, it can be determined that searching users submit one or more subsequent search queries, e.g., as a next search query after having submitted the particular search query. Submissions of the one or more subsequent search queries can each be provided as an inferred action. As another example, for search results that are displayed in response to a particular search query, it can be determined that searching users often select one or more particular search results. Respective selections of the one or more particular search results can each be provided as an inferred action.

In some implementations, and in the case of multiple inferred actions, the inferred actions can be provided in a ranked order. For example, it can be determined that, for a search query [W], searching users have been seen to subsequently submit a search query [X], a search query [Y] and/or a search query [Z]. In some examples, it can be determined that the search query [Y] is submitted subsequent to the search query [W] with a greater frequency than the search query [Z], and that the search query [Z] is submitted subsequent to the search query [W] with a greater frequency than the search query [X]. Consequently, an example ranked order can include: search query [Y], search query [Z], search query [X].

In some implementations, and in the case of multiple inferred actions, the inferred actions can be capped at a threshold number of inferred actions. For example, instead of providing content associated with all of the inferred actions, a subset of the inferred actions can be provided. Continuing with the example above, the inferred actions associated with submission of the search query [W] can include submission of the search query [Y], submission of the search query [Z], and submission of the search query [X], e.g., in ranked order. It can be provided that the threshold number of inferred actions is two. Consequently, submission of the search query [X] can be filtered from the inferred actions, and content associated with the submission of the search query [Y] and submission of the search query [Z] can be provided.

In some implementations, the one or more inferred actions can be dynamic. That is, for example, a particular search query can be associated with a first set of inferred actions at a first time, and a second set of inferred actions at a second time. For example, the first set of inferred actions can be provided based on processing of the one or more search logs prior to the first time, and the second set of inferred actions can be provided based on processing of the one or more search logs after the first time and before the second time. Accordingly, the inferred actions can be dynamically determined as searching behavior of searching users, e.g., aggregate user actions, changes over time.

In some implementations, content associated with one or more rule-based actions can also be provided, e.g., in search results. In some examples, a rule-based action can include an action based on a predefined rule. In some examples, if one or more conditions of the rule are met, a rule-based action can be provided. For example, a rule can provide that, if a user submits a search query to search for a flight that the user has in the next 24 hours, traffic and/or weather information is to be provided with the search results. In this example, the rule-based action includes retrieving and displaying traffic and/or weather information. Such rule-based actions stand in contrast to inferred actions, which are based on aggregate user actions, as discussed above.

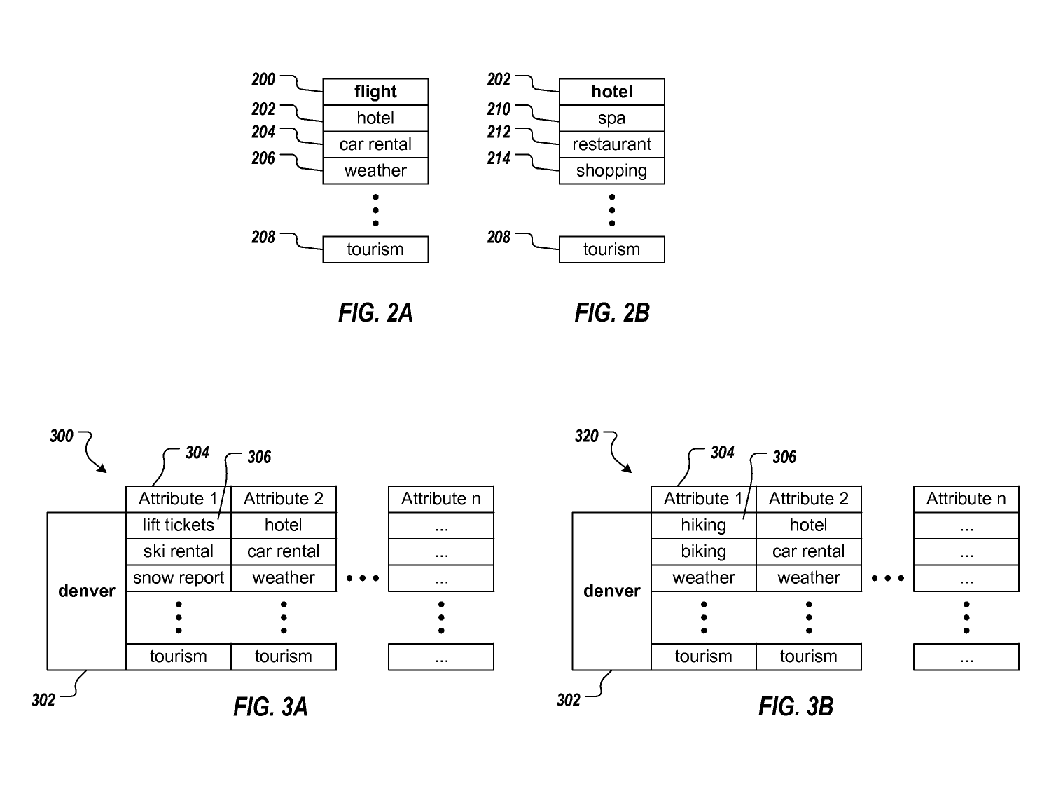

FIGS. 2A and 2B depict example inferred actions based on respective example search queries. In the examples of FIG. 2A and 2B, example search queries include [flight] 200 and [hotel] 202. Referring to FIG. 2A, in response to the search query [flight] 200 being received, it can be determined, e.g., by the inferred action system 130 of FIG. 1, that inferred actions can include submissions of the search query [hotel] 202, a search query [car rental] 204, a search query [weather] 206, and a search query [tourism] 208. That is, and in the example of FIG. 2A, it can be determined that, on aggregate, users that submit the search query [flight] 200 subsequently submit at least one of the search queries 202, 204, 206, 208. In accordance with implementations of the present disclosure, content associated with the search queries 202, 204, 206, 208 can be displayed with search results that are provided in response to the submitted search query 200. In some examples, the content associated with the search queries 202, 204, 206, 208 can include respective search results that would be displayed, if the respective search queries 202, 204, 206, 208 would be submitted. In some examples, the search queries 202, 204, 206, 208 are provided in a ranked order, as discussed above.

Referring to FIG. 2B, in response to the search query [hotel] 202 being received, it can be determined, e.g., by the inferred action system 130 of FIG. 1, that inferred actions can include submissions of a search query [spa] 210, a search query [restaurant] 212, a search query [shopping] 214, and the search query [tourism] 208. That is, and in the example of FIG. 2B, it can be determined that, on aggregate, users that submit the search query [hotel] 202 subsequently submit at least one of the search queries 210, 212, 214, 208. In accordance with implementations of the present disclosure, content associated with the search queries 210, 212, 214, 208 can be displayed with search results that are provided in response to the submitted search query 200. In some examples, the content associated with the search queries 210, 212, 214, 208 can include respective search results that would be displayed, if the respective search queries 210, 212, 214, 208 would be submitted. In some examples, the search queries 210, 212, 214, 208 are provided in a ranked order, as discussed above.

FIGS. 3A and 3B depicts example inferred actions based on an example search query, user attributes, and respective seasonal indicators. For example, FIG. 3A provides an example inferred action table 300 that can correspond to winter months in the northern hemisphere, and FIG. 3B provides an example inferred action table 320 that can correspond to non-winter months in the northern hemisphere. In the depicted examples, each of the inferred action tables 300, 320 is based on an example search query [Denver] 302. Each of the inferred action tables includes columns 304, each column reflecting one or more attributes associated with users. As discussed above, attributes can include topics that the user has been determined to be interested in. Non-exhaustive, example topics can include music, sports, food, technology, gardening, airplanes, cars, movies, video games and the like. For each column 304, one or more cells 306 are provided, each cell 106 being populated with a respective inferred action. In the example of FIGS. 3A and 3B, the inferred actions include search queries that could be submitted to a search service, e.g., the search service 120 of FIG. 1.

With particular reference to FIG. 3A, example inferred actions associated with the search query [Denver] 302 and the attribute “Attribute 1” include a search query [lift tickets], a search query [ski rental], a search query [snow report], and a search query [tourism]. For example, Attribute 1 can indicate an interest in sporting activities. Example inferred actions associated with the search query [Denver] 302 and the attribute “Attribute 2” include a search query [hotel], a search query [car rental], a search query [weather], and a search query [tourism]. For example, Attribute 2 can indicate an interest in travel.

With particular reference to FIG. 3B, example inferred actions associated with the search query [Denver] 302 and the attribute “Attribute 1” include a search query [hiking], a search query [biking], a search query [weather], and a search query [tourism]. For example, and as discussed above with reference to FIG. 3A, Attribute 1 can indicate an interest in sporting activities. Example inferred actions associated with the search query [Denver] 302 and the attribute “Attribute 2” include a search query [hotel], a search query [car rental], a search query [weather], and a search query [tourism]. For example, and as discussed above with reference to FIG. 3A, Attribute 2 can indicate an interest in travel.

With reference to FIGS. 3A and 3B, a user can submit the search query [Denver] 302 to a search service, e.g., the search service 120 of FIG. 1. It can be determined that inferred actions are to be displayed with search results, the search results being responsive to the search query 302. It can also be determined that the user submitted the search query 302 in a winter month, e.g., February, and that the user is associated with Attribute 1, e.g., is interested in sporting activities. Consequently, the inferred action table 300 of FIG. 3A can be referenced to determined inferred actions that can be represented with the search results. In this example, the inferred actions can include submission at least one of the search queries [lift tickets], [ski rental], [snow report], and [tourism], and content associated with one or more of the search queries [lift tickets], [ski rental], [snow report], and [tourism] can be displayed with search results that are provided in response to the search query [Denver]. In some examples, the content associated with the search queries [lift tickets], [ski rental], [snow report], and [tourism] can include respective search results that would be displayed, if the respective search queries [lift tickets], [ski rental], [snow report], and [tourism]would be submitted. If, on the other hand, the user submitted the search query [Denver] in a non-winter month, e.g., July, the inferred action table 320 of FIG. 3B could be referenced to determine inferred actions to be represented with the search results.

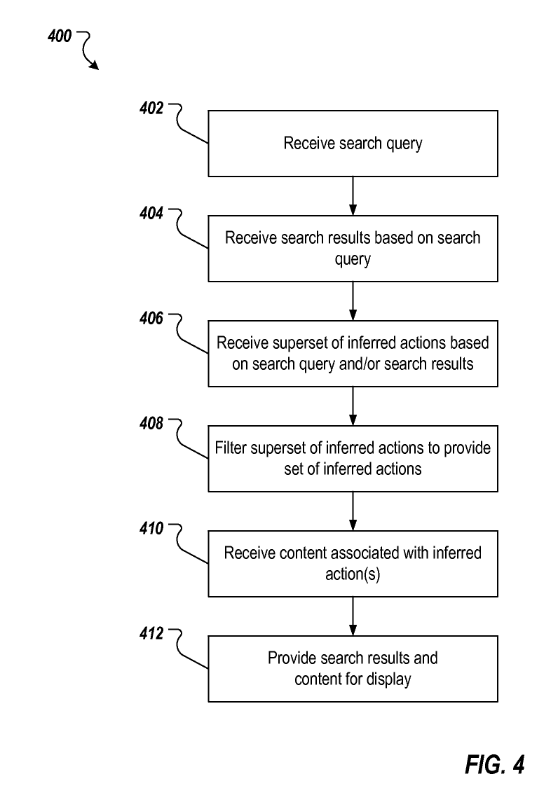

FIG. 4 depicts an example process 400 that can be executed in accordance with implementations of the present disclosure. The example process 400 can be implemented, for example, by the search system 120 in conjunction with the inferred action system 130. In some examples, the example process 400 can be provided by one or more computer-executable programs executed using one or more computing devices. In some implementations, the example process 400 is performed to provide one or more inferred actions in search results.

A query is received (402). For example, and with reference to FIG. 1, a search query 109 can be received by the search system 120 from a user device 106. Search results responsive to the query are received (404). For example, the search system 120 can receive search results from the search index 122, the search results being responsive to the query. A superset of inferred actions is received (406). For example, the search system 120 can receive the superset of inferred actions from the inferred action system 130. In some examples, inferred actions included in the superset of inferred actions are provided based on the search query and/or search results that are to be displayed in response to the search query. In some examples, the superset of inferred actions includes one or more inferred actions.

The superset of inferred actions is filtered to provide a set of inferred actions (408). In some examples, the superset of inferred actions can be filtered based on time, date, and/or one or more attributes associated with the user that submitted the search query, e.g., the searching user. In some examples, inferred actions in the superset of inferred actions can be provided in rank order, and can be filtered based on the rank order, e.g., the bottom X inferred actions are filtered from the superset of inferred actions. In some examples, the set of inferred actions includes one or more inferred actions. In some examples, the set of inferred actions includes all of the inferred actions provided in the superset of inferred actions. In some examples, the set of inferred actions includes a sub-set of the inferred actions provided in the superset of inferred actions.

Content associated with inferred actions of the set of inferred actions is received (410). In some examples, the content can include search results that would be displayed, if inferred actions of the set of inferred actions were to be performed. In some examples, the search system 120 can receive the search results from the search index 122. Search results and content associated with inferred actions of the set of inferred actions are provided for display (412). For example, the search system provides the search results and the content associated with inferred actions of the set of inferred actions for display in the search result display 111.

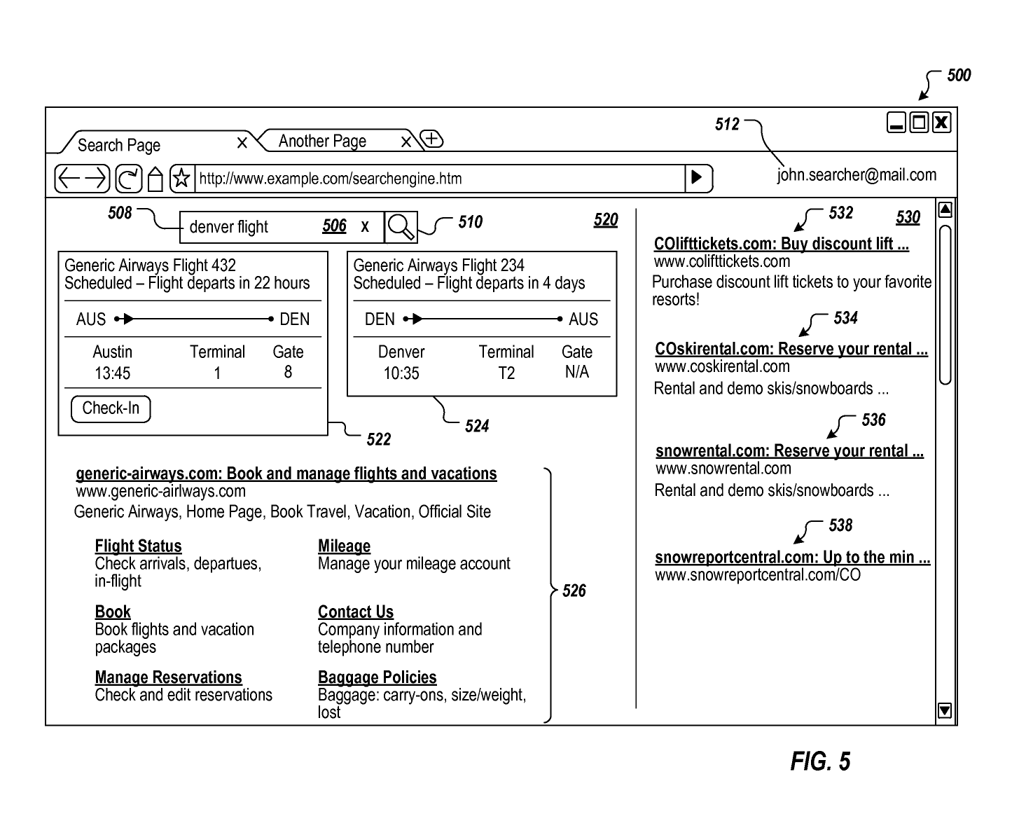

FIG. 5 depicts a screen shot of an example search interface in which content associated with inferred actions is presented with search results in a search results display 500. Although the example search result display 500 is depicted as a web page inside a web browser, this is for context only, and is not intended to limit the scope of the present disclosure to any one web browser or even to implementations involving serving a web page.

The example search results display 500 includes a search box 506. In some implementations, the search box 506 may be a text box specified using an appropriate machine-readable language, e.g., HTML. In implementations, the search box 506 may be a custom component specified by another suitable web development language such as Javascript. The illustrated search box 506 includes a search query 508. In the depicted example, the search query includes [denver flight]. In some examples, the search query 508 may be entered by a user. In some examples, the search query 508 may be programmatically received through an application programmer interface (API) or other suitable means. The illustrated search box 506 is also associated with a search button 510. In some examples, a user may perform a search based on the search query 508 by activating, e.g., clicking on, the search button 510. This activation may be performed by any appropriate mechanism such as clicking the search button 510 with a pointing device, e.g., a mouse, or pressing a key or combination of keys on a keyboard. In some examples, the search query 508 can be automatically submitted as it is being entered.

The illustrated search results display 500 also includes user information 512. In the illustrated example, the user information 512 indicates that the user “john.searcher@mail.com” is currently logged in. As discussed above, personal search results, e.g., data records, can be displayed. For example, the personal search results can be specific to the user john.searcher@mail.com in the depicted example. In some implementations, the search results display 500 might not include an indication of the current user, but the search query 508 may still be processed according to the current user.

The illustrated search results display 500 includes a search results pane 520 and an inferred actions pane 530. In the depicted example, the search results pane 520 includes one or more search results 522, 524, 526. In some implementations, the search results pane 520 is a frame segregating the search results from other panes of the search results display 500, e.g., the inferred actions pane 530. In some implementations, the search results pane 520 is provided as a consecutive list of search results. In the depicted example, the inferred actions pane 530 includes content 532, 534, 536, 538 associated with one or more inferred actions. In the depicted example, the content 532, 534, 536, 538 includes search results that would be displayed, if one or more search queries were to be submitted as respective inferred actions.

In the example of FIG. 5, the search query 508 [denver flight] was entered by the user and was processed by a search system, e.g., the search system 120 of FIG. 1. In the depicted example, it was determined that a set of inferred actions is to be represented with search results. Consequently, the inferred actions pane 530 is populated with content associated with one or more inferred actions.

For example, it can be determined that inferred actions are to be represented in search results, that the user “john.searcher@mail.com” is interested in sporting activities, and that the search query 508 was submitted in a winter month, e.g., February. Consequently, and in view of the search query 508 and/or the search results 522, 524, 526, example inferred actions can include submission of search queries [lift tickets], [ski rental] and [snow report]. The content 532, 534, 536, 538 includes search results that would be displayed, if the search queries [lift tickets], [ski rental] and [snow report] were to be submitted.

In some examples, whether inferred actions are to be represented in search results can be determined based on whether an item is to be displayed with search results. In the example of FIG. 5, example items include personal search results 522, 524, which include user-specific data records, e.g., reflecting the user's flights on a fictional airline, Generic Airways. In some examples, it can be determined that the personal search results 522, 524 are to be displayed and, consequently, it can also be determined that inferred actions are to be represented with search results.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback;

and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method executed using one or more processors, the method comprising:
receiving, by the one or more processors, a search query;
receiving, by the one or more processors, a set of inferred actions comprising two or more inferred actions that are determined based at least partly on data indicating one or more other search queries that were submitted after at least one other submission of the search query, the data provided in one or more data sources, wherein each of the two or more inferred actions is a distinct inferred search query that is different from the received search query;
providing, by the one or more processors, an electronic document comprising instructions that, when executed by a computing device, cause the computing device to display a search results page comprising (i) search results for the search query, and (ii) a respective search result and content associated with each of the two or more inferred search queries of the two or more inferred actions of the set of actions without displaying a presentation of the respective inferred search queries; and
transmitting, by the one or more processors, the electronic document to provide the search results page to be displayed on the computing device associated with a user that submitted the search query.

2. The method of claim 1, wherein an inferred action in the set of inferred actions comprises submission of one of the one or more other search queries.

3. The method of claim 1, wherein content associated with an inferred action comprises a search result that would be displayed in response to submission of one of the one or more other search queries.

4. The method of claim 1, further comprising:
providing a superset of inferred actions; and
filtering the superset of inferred actions to provide the set of inferred actions.

5. The method of claim 1, further comprising determining that inferred actions are to be represented in search results in response to a determination that one or more items are to be displayed in the search results.

6. The method of claim 5, wherein the one or more items comprise at least one of a personal search result and a knowledge panel.

7. The method of claim 1, wherein the one or more inferred actions are further based on search results that are responsive to the query.

8. The method of claim 1, wherein data provided in the one or more data sources comprises aggregate user data.

9. The method of claim 1, wherein at least one data source of the one or more data sources comprises a search log.

10. A system comprising:
a data store for storing data; and
one or more processors configured to interact with the data store, the one or more processors being further configured to perform operations comprising:
receiving a search query;
receiving a set of inferred actions comprising two or more inferred actions that are determined based at least partly on data indicating one or more other search queries that were submitted after at least one other submission of the search query, the data provided in one or more data sources, wherein each of the two or more inferred actions is a distinct inferred search query that is different from the received search query;
providing an electronic document comprising instructions that, when executed by a computing device, cause the computing device to display a search results page comprising search results for the search query, and (ii) a respective search result and content associated with each of the two or more inferred search queries of the two or more inferred actions of the set of actions without displaying a presentation of the respective inferred search queries; and
transmitting the electronic document to provide the search results page to be displayed on the computing device associated with a user that submitted the search query.

11. The system of claim 10, wherein an inferred action in the set of inferred actions comprises submission of one of the one or more other search queries.

12. The system of claim 10, wherein content associated with an inferred action comprises a search result that would be displayed in response to submission of one of the one or more other search queries.

13. The system of claim 10, wherein operations further comprise:
providing a superset of inferred actions; and
filtering the superset of inferred actions to provide the set of inferred actions.

14. The system of claim 10, wherein operation further comprise determining that inferred actions are to be represented in search results in response to a determination that one or more items are to be displayed in the search results.

15. The system of claim 14, wherein the one or more items comprise at least one of a personal search result and a knowledge panel.

16. The system of claim 10, wherein the one or more inferred actions are further based on search results that are responsive to the query.

17. The system of claim 10, wherein data provided in the one or more data sources comprises aggregate user data.

18. The system of claim 10, wherein at least one data source of the one or more data sources comprises a search log.

19. A computer readable medium storing instructions that, when executed by one or more processors, cause the one or more processors to perform operations comprising:
receiving a search query;
receiving a set of inferred actions comprising two or more inferred actions that are determined based at least partly on data indicating one or more other search queries that were submitted after at least one other submission of the search query, the data provided in one or more data sources, wherein each of the two or more inferred actions is a distinct inferred search query that is different from the received search query;
providing an electronic document comprising instructions that, when executed by a computing device, cause the computing device to display a search results page comprising (i) search results for the search query, and (ii) a respective search result and content associated with each of the two or more inferred search queries of the two or more inferred actions of the set of actions without displaying a presentation of the respective inferred search queries; and
transmitting the electronic document to provide the search results page to be displayed on the computing device associated with a user that submitted the search query.

20. The computer readable medium of claim 19, wherein an inferred action in the set of inferred actions comprises submission of one of the one or more other search queries.

21. The computer readable medium of claim 19, wherein content associated with an inferred action comprises a search result that would be displayed in response to submission of one of the one or more other search queries.

22. The computer readable medium of claim 19, wherein operations further comprise:
providing a superset of inferred actions; and
filtering the superset of inferred actions to provide the set of inferred actions.

23. The computer readable medium of claim 19, wherein operation further comprise determining that inferred actions are to be represented in search results in response to a determination that one or more items are to be displayed in the search results.

24. The computer readable medium of claim 23, wherein the one or more items comprise at least one of a personal search result and a knowledge panel.

25. The computer readable medium of claim 19, wherein the one or more inferred actions are further based on search results that are responsive to the query.

26. The computer readable medium of claim 19, wherein data provided in the one or more data sources comprises aggregate user data.

27. The computer readable medium of claim 19, wherein at least one data source of the one or more data sources comprises a search log.
